(19) United States
(12) Patent Application Publication
(10) Pub. No.: US 2026/0057241 A1
(43) Pub. Date: Feb. 26, 2026

(54) FINE-TUNED GENERATIVE MODEL

(71) Applicant: INTERNATIONAL BUSINESS MACHINES CORPORATION, ARMONK, NY (US)

(72) Inventors: Elita Astrid Angelina Lobo, Middletown, CT (US); Nhan Huu Pham, Tarrytown, NY (US); Long VU, Chappaqua, NY (US); Todd William Mummert, Danbury, CT (US); Dharmashankar Subramanian, RYE BROOK, NY (US)

(21) Appl. No.: 18/812,097

(22) Filed: Aug. 22, 2024

(51) Int. Cl. G06N 3/092; G06N 3/0475

(52) U.S. Cl. CPC G06N 3/092; G06N 3/0475

(57) ABSTRACT

A method, computer program product, and computer system for developing a fine-tuned generative model (GM) that receives metadata and multiple choices as input and is configured to select a best choice, from the multiple choices, for describing the metadata. The GM is a neural network of interconnected nodes with each node having an associated weight. Developing the fine-tuned GM includes: (i) generating training data as input for training a pre-trained GM to become the fine-tuned GM, the training data including P input prompts; and (ii) training the pre-trained GM to become the fine-tuned GM, using reinforcement learning and using the training data as input. The training includes: performing a nested iterative process in which N input prompts are sampled randomly from the P input prompts subject to N<P, followed by iteratively using the N input prompts to dynamically update the weights for a maximum of K iterations.

### BACKGROUND

The present invention relates generally to matching metadata to glossary items, and more specifically, to matching metadata to glossary items using a fine-tuned generative model.

### SUMMARY

Embodiments of the present invention provide a method, a computer program product, and a computer system, for developing a fine-tuned generative model (GM) that receives metadata and multiple choices as input and is configured to select a best choice, from the multiple choices, for describing the metadata. One or more processors of a computer system generate training data as input for training a pre-trained GM to become the fine-tuned GM. The training data comprises P input prompts, wherein P is at least 4. Each input prompt of the P input prompts comprises a metadata, multiple choices comprising positive choices and a negative choice, and a best choice of the multiple choices for describing the metadata. The GM is a neural network of interconnected nodes with each node having an associated weight. The one or more processors train the pre-trained GM to become the fine-tuned GM, using reinforcement learning and using the training data as input to the training. The training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then looping back to said performing the nested iterative process in which N new input prompts are sampled randomly from the P input prompts, wherein K is at least 2.

### BRIEF DESCRIPTION OF THE DRAWINGS

FIG. 1 depicts an example of ground truths that map table column metadata to glossary items, in accordance with embodiments of the present invention.

FIG. 2 is a flow chart of a method for developing a fine-tuned generative model (GM) that receives a metadata and multiple choices as input, in accordance with embodiments of the present invention.

FIG. 3 is a flow chart of an iterative process, within the method of FIG. 2, for training a pre-trained generative model (GM) to become the fine-tuned GM, in accordance with embodiments of the present invention.

FIG. 4 is a flow chart of a process describing, in more detail, a step in FIG. 3 which processes the N input prompts to compute an update of weights associated with nodes of the GM, in accordance with embodiments of the present invention.

FIG. 5 is a flow chart of a process describing, in more detail, a step in FIG. 4 which computes a policy optimization loss (L), in accordance with embodiments of the present invention.

FIG. 6 is a flow chart for a process, within the method of FIG. 2, of generating training data for training the pre-trained GM to become the fine-tuned GM, in accordance with embodiments of the present invention.

FIG. 7 is a flow chart of a process for describing, in more detail, a step in FIG. 6 of selecting a best choice from multiple choices for describing a metadata, in accordance with embodiments of the present invention.

FIG. 8 is a flow chart of a process, within the method of FIG. 2, for verifying the trained fine-tuned GM, in accordance with embodiments of the present invention.

FIGS. 9 and 10 provide an example illustrating how to determine whether the fine-tuned GM is correct or incorrect according to the verification process described in FIG. 8, in accordance with embodiments of the present invention.

FIG. 11 illustrates a computer system, in accordance with embodiments of the present invention.

FIG. 12 depicts a computing environment which contains an example of an environment for the execution of at least some of the computer code involved in performing the inventive methods, in accordance with embodiments of the present invention.

### DETAILED DESCRIPTION

According to an aspect of the invention, a fine-tuned generative model (GM) is developed. The fine-tuned GM receives a metadata and multiple choices as input and is configured to select a best choice, from the multiple choices, for describing the metadata. One or more processors of a computer system generate training data as input for training a pre-trained GM to become the fine-tuned GM. The training data comprises P input prompts, wherein P is at least 4. Each input prompt of the P input prompts comprises a metadata, multiple choices comprising positive choices and a negative choice, and a best choice of the multiple choices for describing the metadata. The GM is a neural network of interconnected nodes with each node having an associated weight. The one or more processors train the pre-trained GM to become the fine-tuned GM, using reinforcement learning and using the training data as input to the training. The training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then looping back to said performing the nested iterative process in which N new input prompts are sampled randomly from the P input prompts, wherein K is at least 2.

The preceding aspect of the invention advantageously generates training data that includes prompts with multiple choices that include both positive choices and a negative choice, so that the prompt provides more context to assist the GM to output improved descriptions of the metadata with increased efficiency.

In addition, the preceding aspect of the invention advantageously selects random prompts from the input prompts to enable the GM to be trained in a manner that results in the fine-tuned GM having increased accuracy.

In first embodiments, each iteration k (k=1, . . . , K) of the iterative process that trains the pre-trained GM to become the fine-tuned GM includes: randomly sampling I input prompts from the N input prompts, wherein I<N; for each input prompt i of the I input prompts: tokenizing input prompt i into p input tokens resulting in generation of T+1 output tokens; and for each output token t (t=0, . . . , T) of input prompt i, computing a reward (R_{i,t}) that combines a Kullback-Leibler (KL) reward with a similarity-based reward that depends on a similarity score between the GM's output and the multiple choices of input prompt i; computing a policy optimization loss (L) based on the rewards R_{i,t} for all of the T+1 output tokens for each of the I input prompts; and updating each node based by an additive amount Δ∇L, wherein α is an inputted constant learning rate and ∇L is a gradient of L that is specific to each node.

The preceding first embodiments provide technical features based on using a novel reward that combines a Kullback-Leibler (KL) reward with a similarity-based reward that depends on a similarity score between the GM's output and the multiple choices of an input prompt, which provides better performance than using only a similarity-based reward function such as cosine similarity and which advantageously can be used by any reinforcement learning algorithm to train the GM.

In second embodiments, if t<T then the reward Ri,t is the KL reward, and if t=T then the reward Ri,t is a sum of the KL reward and the similarity-based reward.

The preceding second embodiments provide a technical feature of limiting use of the similarity-based reward to time step T for increased efficiency in the training of the pre-trained GM.

In third embodiments, the similarity-based reward is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

The preceding third embodiments provide a technical feature of balancing the positive choices with the negative choice via the respective coefficients in the linear combination, which results in a more balanced reward for more efficiently training the pre-trained GM.

In fourth embodiments, determining whether the iterative process has converged comprises determining whether ∥∇L∥²≤ε at each node for a specified tolerance ε, and if so or if not then determining that the iterative process has converged or has not converged, respectively.

The preceding fourth embodiments provide a technical feature of a convergence criteria of ∥∇_{L}∥²≤ε, which speeds up the convergence of the weights associated with the nodes.

In fifth embodiments, generating the training data comprises: providing a list of metadata, a list of glossary items, and a ground truth for one or more metadata wherein for each metadata having a ground truth, the ground truth points to one or more glossary items, and wherein each glossary item comprises a label and a description, and for each metadata: computing a similarity metric in an embedding space between the metadata and each glossary item in the list of glossary items; selecting H glossary items in the list of glossary having H highest similarity metrics; randomly selecting H sub-chunks, each sub-chunk of size G being a subset of the H glossary items, wherein G<H; for each sub-chunk s (s=1, . . . , S): (i) generating a multiple choice input prompt comprising the metadata, G+1 choices consisting of the G glossary items as positive choices and a none-of-the-above (NOTA) choice as a negative choice; and (ii) selecting a best choice of the G+1 choices, wherein the multiple choice input prompt further comprises the best choice.

The preceding fifth embodiments provide a technical feature of including random sub-chunks, which increases the scope of the input prompts used to train the pre-trained GM and thus increases the accuracy of the fine-tuned GM resulting from the training.

In sixth embodiments, selecting the best choice comprises: ascertaining whether a ground truth pointing to at least one choice of the G positive choices for the metadata exists, and if so then selecting the best choice as being one choice of the at least one choice, and if not selecting the best choice as being the NOTA choice.

The preceding sixth embodiments provide a technical feature of using ground truth to distinguish between the correct choice and the incorrect choices, which enables the training data to be generated with increased efficiency.

In seventh embodiments, the method comprises: verifying, by the one or more processors, the fine-tuned GM; and executing, by the one or more processors, the verified fine-tuned GM to determine descriptions of given metadata.

The preceding seventh embodiments provide technical features of (i) verifying the fine-tuned GM, which enables the fine-tuned GM to be used with confidence; and (ii) executing the verified fine-tuned GM, which enables performance of practical applications using the fine-tuned GM to match metadata with descriptions with increased accuracy.

Given a set of metadata and a set of glossary items, where each glossary item includes a label and a description, embodiments of the present invention are directed to using a fine-tuned generative model (GM) to determine a description of a metadata that is inputted to the GM.

A generative model is a form of artificial intelligence (AI) that uses machine learning to discover patterns in data in order to generate new, similar data.

The generative model is trained, in accordance with embodiments of the present invention, using text including words, phrases, and/or sentences. In one embodiment, the generative model uses a neural network

In one embodiment, the generative model is a language model that uses a neural network for predicting and generating language.

In one embodiment, the generative model is a large language model (LLM), which is a language model structured as a neural network and is trained on a large amount of training data.

Embodiments of the present invention train a pre-trained generative model (GM), using reinforcement learning and using training data as input, to become a fine-tuned GM.

The training data includes input prompts, wherein each input prompt includes a metadata, multiple choices comprising positive choices and a negative choice, and a best choice of the multiple choices for describing the metadata.

Embodiments of the present invention generate input prompts of the training data using as input: a list of metadata, a list of glossary items, and ground truths. Each ground truth maps a metadata to one or more glossary items of the list of glossary items. The description in each glossary item to which a metadata is mapped by a ground truth is a correct description of the glossary item.

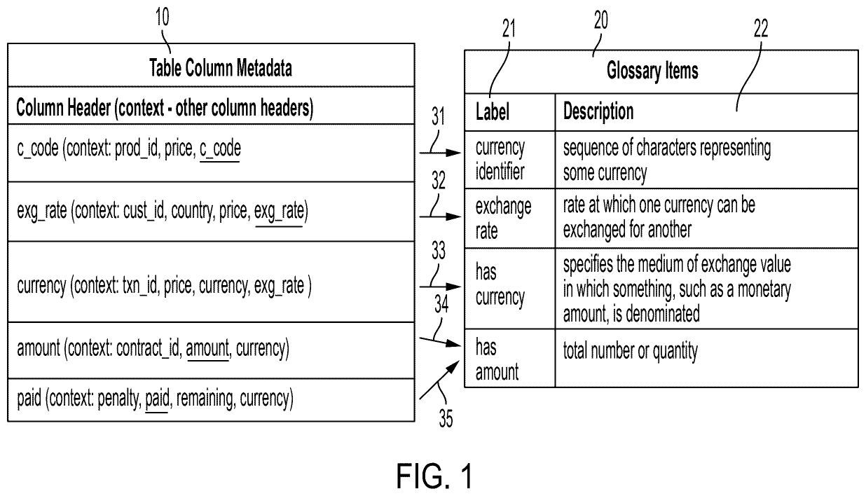

FIG. 1 depicts an example of ground truths (31-35) that map table column metadata 10 to glossary items 20, in accordance with embodiments of the present invention.

FIG. 1 provides an example of data, including metadata, glossary items and ground truths, used for generating training data to train a pre-trained GM to become a fine-tuned GM.

Each metadata in the table column metadata 10 is a column header of a table.

The context of each metadata is shown by the position of each metadata in a sequence of other column headings.

The glossary items 20 each includes a label 21 and a description 22. The descriptions 22 are candidates for describing the metadata in table column metadata 10.

The ground truths 31-35 map the metadata in table column metadata 10 to the glossary items 20 to provide correct descriptions 22 of the metadata. For example, ground truth 33 maps the metadata “currency” to the glossary item whose label is “has currency” and whose description of “specifies the medium of exchange value in which something, such as a monetary amount, is denominated” which correctly describes the metadata “currency”.

It is noted that metadata “amount” and metadata “paid” are each mapped, by respective ground truths 34 and 35, to the same glossary item whose label is “has amount” and whose description is “total number or quantity”. Thus, in some embodiments, one or more metadata may map to the same glossary item by respective ground truths.

Although each metadata in the table column metadata 10 has a ground truth that maps to (i.e., points to) one or more glossary items, a ground truth is not generally required for each metadata.

The embodiment of a ground truth mapping a metadata to more than one glossary item, which is not explicitly shown in FIG. 1, provides correct alternative descriptions of the metadata.

If a ground truth maps a metadata to at least one glossary item, then the ground truth is said to point to the at least one glossary item, as illustrated by the arrows of ground truths 31-35.

Although each metadata in the table column metadata 10 is a column header of a table, the metadata generally may exist in any data structure (e.g., table, list, etc.) and may be any data that describes, annotates, or gives information about other data.

The training data, which is used to train a pre-trained GM to become a fine-tuned GM, comprises P input prompts, wherein P is at least 4. Each input prompt of the P input prompts comprises a metadata, multiple choices comprising positive choices and a negative choice of the multiple choices, and a best choice of the multiple choices for describing the metadata.

A positive choice is defined as a glossary description of the metadata.

A negative choice is defined as a none-of-the-above (NOTA) choice, which means that none of the positive choices of the multiple choices correctly describe the metadata.

The following example illustrates input prompts derived from a list of metadata and a list of glossary items. In this example, the metadata are column names of columns in a table. In this example, one metadata in the list of metadata is a main metadata; i.e., a main column name.

In the list of metadata, the main column name in the table is “customer status” and the other column names are: status review, industry code, customer tenure range, customer active tenure range, staff turnover range, legal form, staffing structure, purpose, franchised, customer status tenure range, organization customer profile id, customer market segment, customer profitability segment, revenue range, profit after tax range, amount owed range, importance level, age range, preferred payment method, debit credit status, spoken language, location country, introduction.

The multiple choices in an exemplary input prompt are the following choices 1-5 in Table 1, wherein choices 1-4 are positive choices and choice 5 is a negative choice.

TABLE 1
Multiple Choices of an Input Prompt

| Choice | Description |
|---|---|
| 1 | a term that distinguishes between customers according to the |
| | specific life cycle state in which the customer relationship |
| | exists |
| 2 | identifies a business activity in which the status of an item is |
| | reviewed to determine if it is still valid; for example; |
| | confirmation of bankruptcy status of an individual |
| 3 | identifies the number of involved parties with whom the |
| | financial institution has product arrangements |
| 4 | Identify an involved party that is eligible to avail itself of the |
| | financial institution's products and services. both organizations |
| | and individuals must undergo stringent vetting before they can |
| | become a customer of any financial institution |
| 5 | none-of-the-above |

For the metadata of the column name “status review”, the best choice is the positive choice 2, namely “identifies a business activity in which the status of an item is reviewed to determine if it is still valid; for example; confirmation of bankruptcy status of an individual”.

For the metadata of the column name “number of customers”, the best choice is the negative choice 5, namely “none-of-the-above” (NOTA), because “number of customers” is not in the list of metadata.

Training the pre-trained GM to become the fine-tuned GM includes iteratively processing N input prompts of the P input prompts in the training data, wherein N<P.

The training processes the N input prompts in an iterative process for a maximum number (K) of iterations. In each iteration, a minibatch of I input prompts of the N input prompts are randomly selected, wherein I<N.

For each input prompt i (i=1, . . . , I), p input tokens are determined from the input prompt i. The set of p input tokens is denoted as p.

Let q_{0:t} denote a sequence of T+1 output tokens (at respective time-steps 0, . . . , T) generated by the GM for input prompt i in iteration k (k=1, . . . , K) until time-step t≤T where q_{0:T} is the full output at the end of time-step T. Output token t is generated by the GM from the p input tokens in time-step t (t=0, . . . , T).

Each input token of the p input tokens is a unit of text (e.g., a word or a sub-word) generated from the input prompt by a transformer within the GM. The output tokens are units of text generated by the GM.

Let E denote a set of G+1 embeddings of the G+1 choices consisting of G positive choices and one negative choice in the input prompt. In the example of Table 1 discussed supra, G=4. Each embedding g corresponds to choice g (g=1, . . . , G+1).

An embedding is a vector of floating point numbers generated, by a sentence transformer, from the input tokens in each choice.

Let π and π₀ denote the fine-tuned GM and the pre-trained GM, respectively.

For the input prompt i of the I input prompts at time-step t, the state i is denoted as s_{i,t} and the action is denoted as a_{i,t}, wherein s_{i,t}=p+q_{0:t-1} and a_{i,t}=qₜ.

Using reinforcement learning, a reward Ri,t at time-step t is computed in response to the action a_{i,t} as a combination of a Kullbach-Leibler (KL)-based reward (R_{KL}) and a similarity-based reward (R_{SEM}).

$$\begin{matrix}At t < T , R ( {a}_{i , t} ) = {R}_{KL} ( p + {q}_{0 : t - 1} , {q}_{t} ) \\ At t = T , R ( {a}_{i , T} ) = {R}_{KL} ( p + {q}_{0 : t - 1} , {q}_{t} ) + {R}_{SIM} ( {C}_{gen} , {C}_{true} )\end{matrix}$$

C_{gen} is an embedding corresponding to the generated output from the GM in input prompt i.

Cₜᵣᵤₑ is a embedding corresponding to the best choice of the multiple choices in input prompt i.

R_{KL}(p+q_{0:t-1}, qₜ) is a Kullbach-Leibler (KL) divergence which is a measure of an extent to which the fine-tuned GM (π) deviates from the pre-trained GM (π₀) and is expressible in Equation (1) as D(f∥g) in terms of probability density functions f(x) and g(x) representing the fine-tuned GM (π) and the pre-trained GM (π), respectively.

$$D ( f ‖ g ) = \int f ( x ) log ( f ( x ) / g ( x ) ) dx \qquad ( 1 )$$

In practice, the numerical calculation of D(f|g) may be analytically intractable.

In one embodiment, R_{KL}(p+q_{0:t-1}, qₜ) may be approximated as follows.

R_{KL}(p+q_{0:t-1},qₜ)∝−log (π(p+q_{0:t-1})/π₀(p+q_{0:t-1})), wherein ∝ means “proportional to”.

In one embodiment, R_{KL}(p+q_{0:t-1}, qₜ) may be approximated vias use of Monte Carlo sampling, as discussed in APPROXIMATING THE KULLBACK LEIBLER DIVERGENCE BETWEEN GAUSSIAN MIXTURE MODELS, published in 2007 IEEE International Conference on Acoustics, Speech and Signal Processing—ICASSP '07, which is incorporated by reference herein in its entirety.

R_{SIM}(C_{gen}, Cₜᵣᵤₑ) is calculated via Equation (2).

$${R}_{SIM} ( {C}_{gen} , {C}_{true} ) = β * {R}_{gt} - ( 1 - β ) * \frac{1}{G} {\sum }_{ic} {R}_{other} \qquad ( 2 )$$

G is the sub-chunk size and there are G+1 number of choices in the multiple choices in input prompt i.
R_{gt} is a similarity score (e.g., cosine similarity) between the GM's output and the correct choice in the embedding space. When there is no ground truth match, R_{gt} is a similarity score between the GM's output and the “none-of-the-above” (NOTA) choice.
Rₒₜₕₑᵣ is a similarity score between the GM's output and an incorrect choice in the embedding space.
Σ_{ic} is a summation over the incorrect choices of the multiple choices.
β is an inputted constant that weights R_{gt} relative to Σ_{ic} Rₒₜₕₑᵣ.

Thus, Equation (2) shows that R_{SIM}(C_{gen}, Cₜᵣᵤₑ) is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

Let R_{i,t} denote the reward. After R_{i,t} is calculated for all combinations of i and t (i.e., i=1, . . . , I and t=0, . . . , T), a policy optimization loss L is calculated via Equation (3).

$$L = \frac{1}{I * T} {\sum }_{i = 1}^{I} {\sum }_{t = 0}^{T} {A}_{i , t} log φ \qquad ( 3 )$$

A_{i,t} is an advantage which is a function A(s, a)=Q(s, a)−V(s), wherein Q(s, a) is an expected cumulative reward resulting from the taking an action a in state s and then following the policy π of the fine-tined GM afterwards, and wherein V(s) is a state-value function, which gives the expected return of being in state s and following the policy π of the fine-tined GM afterwards. See Trust Region Policy Optimization, Proceedings of the 31^{st} International Conference on Machine Learning, Lille, France, 2015. JMLR: W&CP volume 37, which is incorporated by reference herein in its entirety.
φ is a probability of generating the output tokens for input prompt i at time-step t (q_{i,t}) given (i) the input tokens pᵢ for input prompt i at time-step t and (ii) the output tokens q_{0:t-1} for input prompt i at time-step t-1.

In one embodiment, y may be expressed as: φ(a_{i,t}|s_{i,t})=φ(q_{i,t}|pᵢ+q_{i,0:t-1}).

The GM weights Wₖ in iteration k are updated in accordance with Equation (4) using a gradient ascent algorithm to encourage the GM to generate output tokens that lead to higher rewards.

$${W}_{k} = {W}_{k - 1} + α ∇ L \qquad ( 4 )$$

Wₖ denotes the weights at the nodes i in iteration k, and α is a specified learning rate.

∇L, which is the gradient of L, is specific to each node.

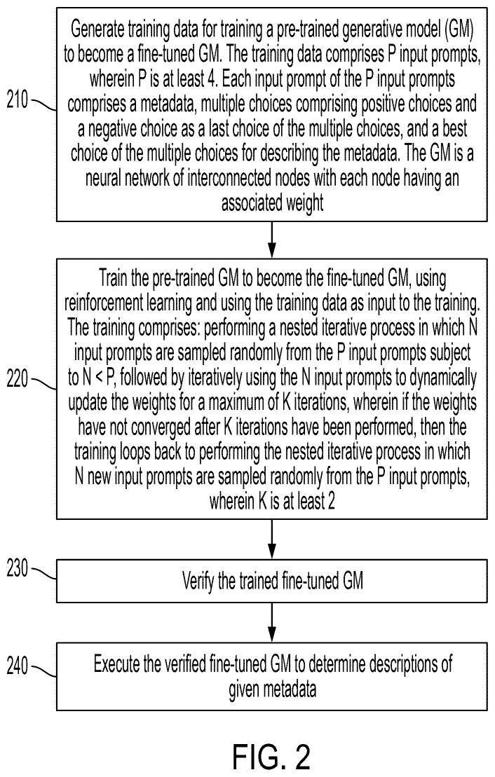

FIG. 2 is a flow chart of a method for developing a fine-tuned generative model (GM) that receives a metadata and multiple choices as input, in accordance with embodiments of the present invention. The fine-tuned GM is configured to select a best choice, from the multiple choices, for describing the metadata. The method of FIG. 2 includes steps 210-240.

Step 210 generates training data for training a pre-trained generative model (GM) to become a fine-tuned GM. The training data comprises P input prompts, wherein P is at least 4. Each input prompt of the P input prompts comprises a metadata, multiple choices comprising positive choices and a negative choice as a last choice of the multiple choices, and a best choice of the multiple choices for describing the metadata. The GM is a neural network having layers of interconnected nodes with each node having an associated weight. The weights dynamically change as the pre-trained GM is being trained to become the fine-tuned GM.

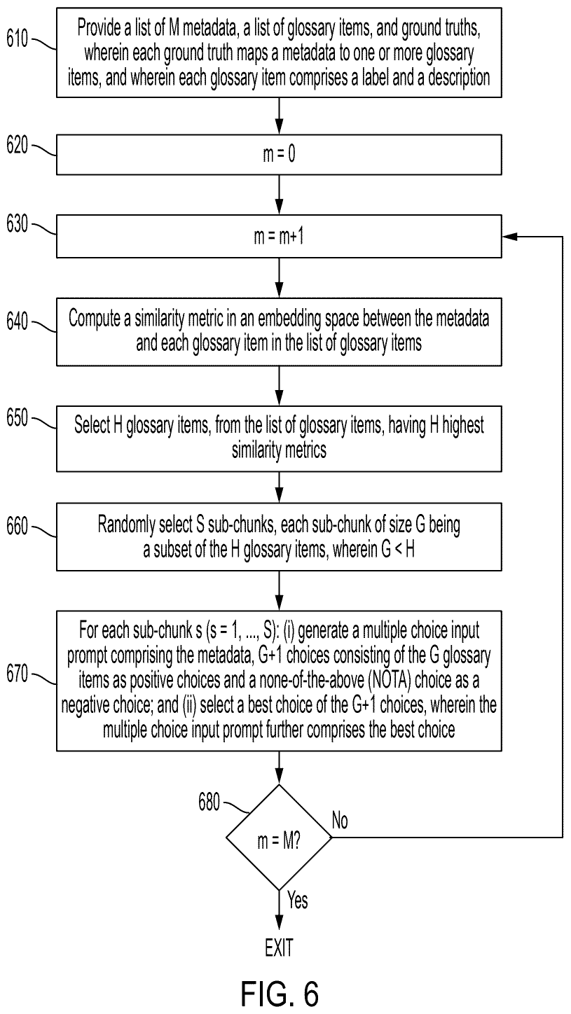

Step 210 is described infra in more detail in FIG. 6.

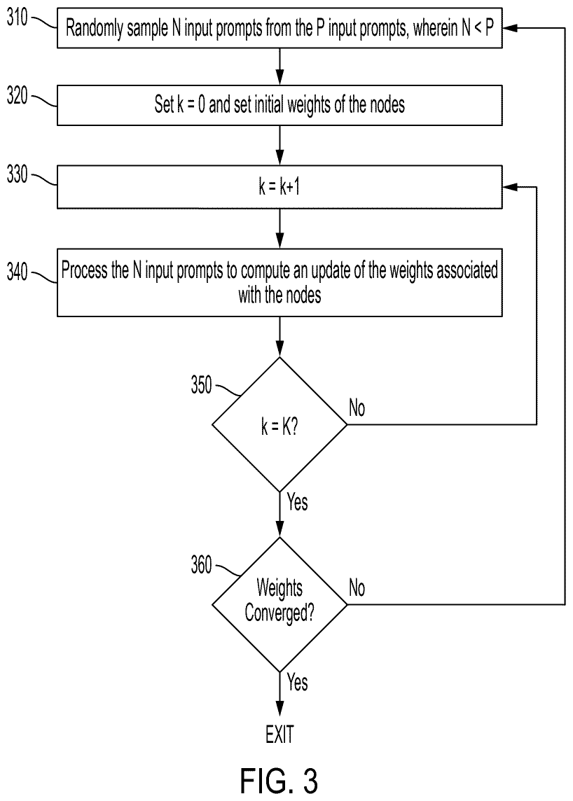

Step 220 trains the pre-trained GM to become the fine-tuned GM using reinforcement learning and using the training data as input to the training. The training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then the training loops back to performing the nested iterative process in which N new input prompts are sampled randomly from the P input prompts, wherein K is at least 2. The iterative process is described infra in FIG. 3.

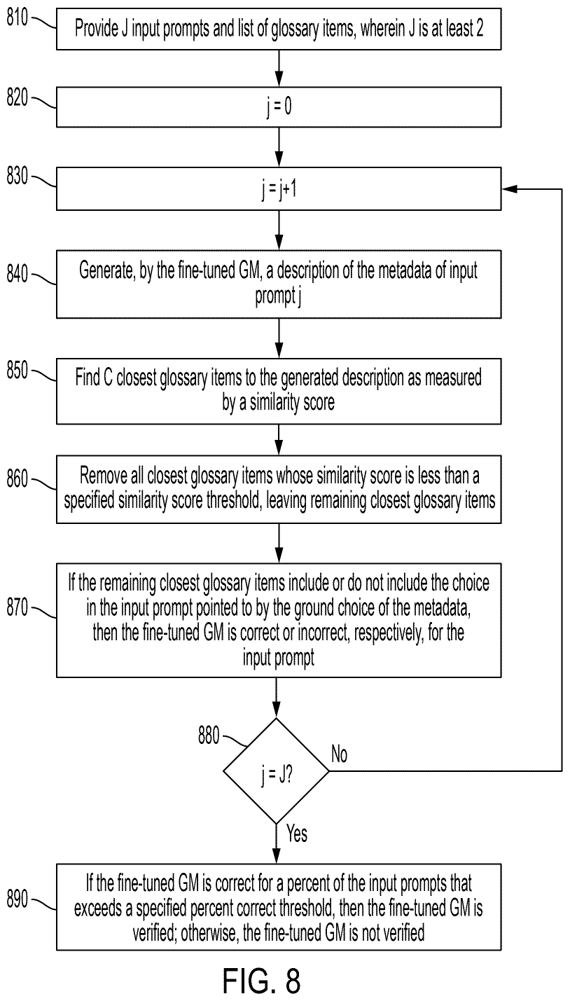

Step 230 verifies that the trained fine-tuned GM outputs correct results. The verification in step 230 is a process of verifying that the trained fine-tuned GM satisfies criteria for generating correct results. Step 210 is described infra in more detail in FIG. 8.

Step 240 executes the verified fine-tuned GM to determine descriptions of given metadata, by selecting a best choice, from multiple choices, for describing the metadata.

FIG. 3 is a flow chart of the iterative process denoted in step 220 in FIG. 2 for training a pre-trained generative model (GM) to become a fine-tuned GM, in accordance with embodiments of the present invention. The process of FIG. 3 includes steps 310-350.

Step 310 randomly samples N input prompts from the P input prompts, wherein P<N. In one embodiment, the N input prompts are randomly sampled from a uniform probability distribution. In one embodiment, the N input prompts are randomly sampled from a weighted probability distribution in which the P input prompts are individually weighted.

Steps 320-350 perform an iterative process comprising a maximum of K iterations.

Step 320 sets an iteration index k to zero and sets initial weights for the nodes.

Step 330 increments k by 1 so that iteration k is the current iteration of the iterative process.

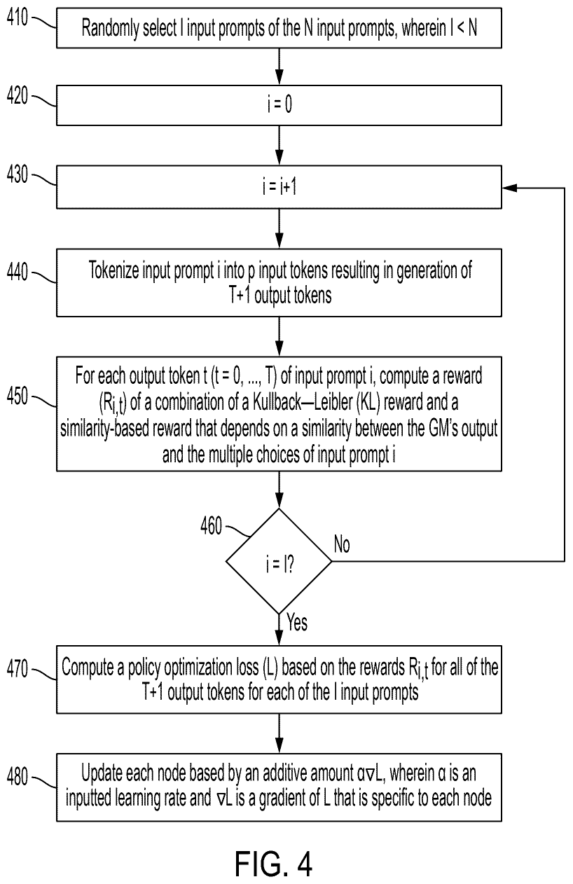

Step 340 processes the N input prompts to compute an update of the weights associated with the nodes. Step 340 is described infra in more detail in FIG. 4.

Step 350 determines whether k=K. If so (Yes branch from step 350), step 360 is next executed. If not (No branch from step 350), the process loops back to step 330 to perform the next iteration k+1.

Step 360 determines whether the weights have converged. If so (Yes branch from step 360), the process of FIG. 3 exits. If not (No branch from step 360), the process loops back to step 310 to randomly sample N new input prompts from the P input prompts.

In one embodiment, the weights have converged if the norm of the gradient ∥∇L∥² of a policy optimization loss (L) is less or equal to than a specified gradient norm threshold c (e.g., 0.01, 0.001, 0.0001, etc.) at each node, as indicated in Equation (5).

$${‖ ∇ L ‖}^{2} \leq ϵ \qquad ( 5 )$$

FIG. 4 is a flow chart of a process describing in more detail step 340, in FIG. 3, which processes the N input prompts to compute an update of the weights associated with the nodes, in accordance with embodiments of the present invention. The process of FIG. 4 includes steps 410-480.

Step 410 randomly samples I input prompts from the N input prompts, wherein I<N. In one embodiment, the I input prompts are randomly sampled from a uniform probability distribution. In one embodiment, the I input prompts are randomly sampled from a weighted probability distribution in which the N input prompts are individually weighted.

Step 420 sets an iteration index i to zero.

Steps 430-460 perform an iterative process comprising I iterations.

Step 430 increments i by 1 so that iteration i is the current iteration of the iterative process.

Step 440 tokenizes input prompt i into p input tokens, resulting in generation of T+1 output tokens.

Step 450 computes, for each output token t (t=0, . . . , T) of input prompt i, a reward (R_{i,t}) that combines a Kullback-Leibler (KL) reward with a similarity-based reward that depends on a similarity score between the GM's output and the multiple choices of input prompt i.

At t<T, the reward R_{i,t} is the KL reward.

At t=T, the reward R_{i,T} is a sum of the KL reward and the similarity-based reward.

As discussed supra in conjunction with Equation (2), the similarity-based reward is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

Step 460 determines whether i=I. If so (Yes branch from step 460), step 470 is next executed. If not (No branch from step 460), the process loops back to step 430 to perform the next iteration i+1.

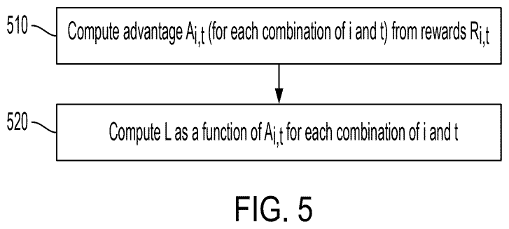

Step 470 computes a policy optimization loss (L) based on the rewards R_{i,t} for all of the T output tokens (t=1, . . . , T) for each of the I input prompts (i=1, . . . , I). Step 470 is described infra in more detail in FIG. 5.

Step 480 updates each node based by an additive amount Δ∇L, wherein α is an inputted constant learning rate and ∇L is a gradient of the policy optimization loss L. It is noted that ∇L is specific to each node.

FIG. 5 is a flow chart of a process describing computation of a policy optimization loss (L), in accordance with embodiments of the present invention. The process of FIG. 5, which describes step 470 of FIG. 4 in more detail, includes steps 510-520.

Step 510 computes an advantage Δ_{i,t} from the rewards R_{i,t} for i=1, . . . , I and t=0, . . . , T.

As discussed supra, the advantage Δ_{i,t} is a function A(s, a)=Q(s, a)−V(s), wherein Q(s, a) is an expected cumulative reward resulting from the taking an action a in state s and then following the policy π of the fine-tined GM afterwards, and wherein V(s) is a state-value function, which gives the expected return of being in state s and following the policy π of the fine-tined GM afterwards.

Step 520 computes L in accordance with Equation (3) discussed supra.

FIG. 6 is a flow chart for a process of generating training data for training a pre-trained generative model (GM) to become a fine-tuned GM, in accordance with embodiments of the present invention. The process of FIG. 6, which describes step 210 of FIG. 2 in more detail, includes steps 610-680.

Step 610 provides list of M metadata, a list of glossary items, and ground truths, wherein each ground truth maps a metadata to one or more glossary items, and wherein each glossary item comprises a label and a description.

Steps 620-680 perform an iterative process comprising M iterations.

Step 620 sets an iteration index m to zero. The iteration index m points to metadata m (m=1, . . . , M) in the list of M metadata.

Step 630 increments m by 1 so that iteration m is the current iteration of the iterative process.

Step 640 computes a similarity metric (e.g., cosine similarity) in an embedding space between the metadata m and each glossary item in the list of glossary items.

Step 650 selects H glossary items in the list of glossary items having H highest similarity metrics.

Step 660 randomly selects S sub-chunks, each sub-chunk of size G being a subset of the H glossary items, wherein G<H. Each sub-chunk having a size G means that each sub-chunk includes G glossary items.

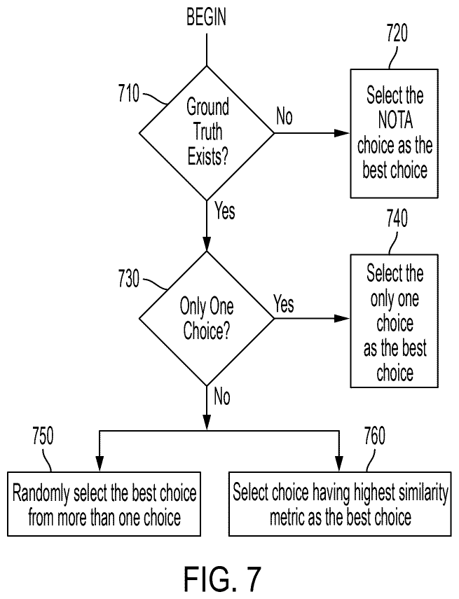

In step 670, for each sub-chunk s (s=1, . . . , S): (i) a multiple choice input prompt is generated, wherein the multiple choice input prompt comprises the metadata, G+1 choices consisting of the G glossary items as positive choices and a none-of-the-above (NOTA) choice as a negative choice; and (ii) a best choice of the G+1 choices is selected, wherein the multiple choice input prompt further comprises the best choice. Selection of the best choice is described infra in FIG. 7.

Step 680 determines whether m=M. If so (Yes branch from step 680), the process of FIG. 6 exits. If not (No branch from step 680), the process loops back to step 630 to perform the next iteration m+1.

FIG. 7 is a flow chart of a process for selecting a best choice from multiple choices for describing a metadata, in accordance with embodiments of the present invention. The process of FIG. 7, which describes selecting the best choice in step 670 of FIG. 6 in more detail, includes steps 710-760.

Step 710 determines whether the metadata has a ground truth. If so (Yes branch from step 710) then step 730 is next executed. If not (No branch from step 710) then step 720 is next executed.

Step 720 selects the none-of-the-above (NOTA) choice as the best choice.

Step 730 determines whether the ground truth maps the metadata to only one choice. If so (Yes branch from step 730) then step 740 is next executed. If not (No branch from step 730) then the ground truth maps the metadata to more than one choice and either step 750 or step 760 is next executed. Steps 750 and 760 are alternative embodiments for selecting the best choice if the ground truth maps the metadata to more than one choice.

Step 750 randomly selects the best choice from the more than one choice. In one embodiment, the best choice is randomly sampled from a uniform probability distribution. In one embodiment, the best choice is randomly sampled from a weighted probability distribution wherein each choice of the more than one choice is individually weighted.

Step 760 selects the choice (of the more than one choice) having the highest similarity metric as the best choice.

FIG. 8 is a flow chart of a process for verifying the trained fine-tuned GM, in accordance with embodiments of the present invention. The verification is a process of verifying that the trained fine-tuned GM satisfies criteria for generating correct results. The process of FIG. 8 includes steps 810-890.

Step 810 provides J input prompts and a list of glossary items, wherein J is at least 2. Each input prompt includes a metadata, multiple choices for describing the metadata, and a ground truth that maps the metadata to the best choice of the multiple choices.

Each input prompt is a test case for which a determination is made as to whether the fine-tuned GM outputs a correct description of an input metadata.

Steps 820-880 perform an iterative process over the J input prompts, wherein each iteration processes a next input prompt of the J input prompts.

Step 820 sets an iteration index j to zero.

Step 830 increments j by 1 so that iteration j is the current iteration of the iterative process.

Step 840 generates, by the fine-tuned GM, a description of the metadata of input prompt j, wherein the GM selects the description of the metadata from the multiple choices.

Step 850 finds C closest glossary items, from the list of glossary items, to the generated description as measured by a similarity score (e.g., a cosine similarity).

Step 860 removes all closest glossary items, from the C closest glossary items, whose similarity score is less than a specified similarity score threshold, leaving remaining closest glossary items.

In step 870, if the remaining closest glossary items include or do not include the choice in the input prompt pointed to by the ground choice of the metadata, then the fine-tuned GM is correct or incorrect, respectively, for the input prompt.

Step 880 determines whether j=J. If so (Yes branch from step 880), step 890 is next executed. If not (No branch from step 880), the process loops back to step 830 to perform the next iteration j+1.

In step 890, if the fine-tuned GM is correct for a percent of the input prompts that exceeds a specified percent correct threshold, then the fine-tuned GM is verified; otherwise, the fine-tuned GM is not verified.

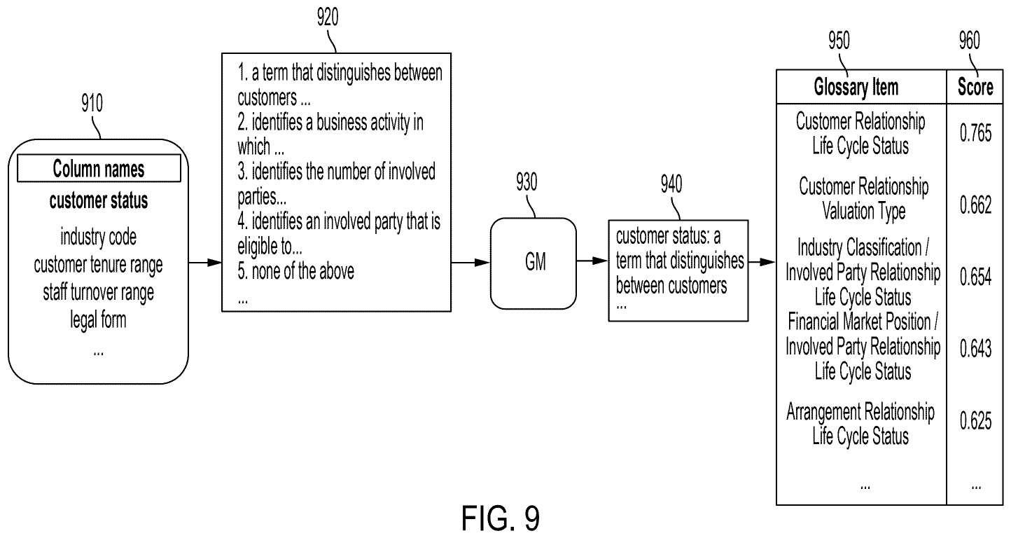

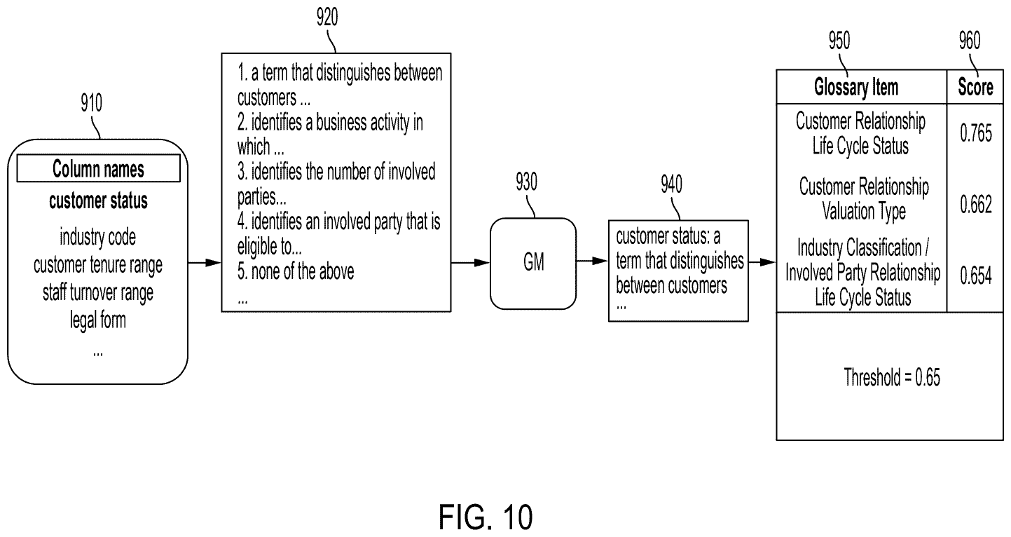

FIGS. 9 and 10 provide an example illustrating how to determine whether the fine-tuned GM is correct or incorrect according to the verification process described in FIG. 8, in accordance with embodiments of the present invention.

In FIG. 9, an input prompt includes a metadata “customer status” (which is in the list of metadata 910) and multiple choices 920. The input prompt is inputted to the fine-tuned GM 930 which generates a description 940 of the metadata “customer status”. The generated description 940 is the first choice of the multiple choices 920. The process finds the 5 closest glossary items 950 (i.e., C=5 in step 850 of FIG. 8) to the generated description 940 as measured by a similarity score 960.

In FIG. 10, 2 closest glossary items whose similarity score is less than a specified similarity score threshold 0.65 have been removed, leaving 3 remaining closest glossary items.

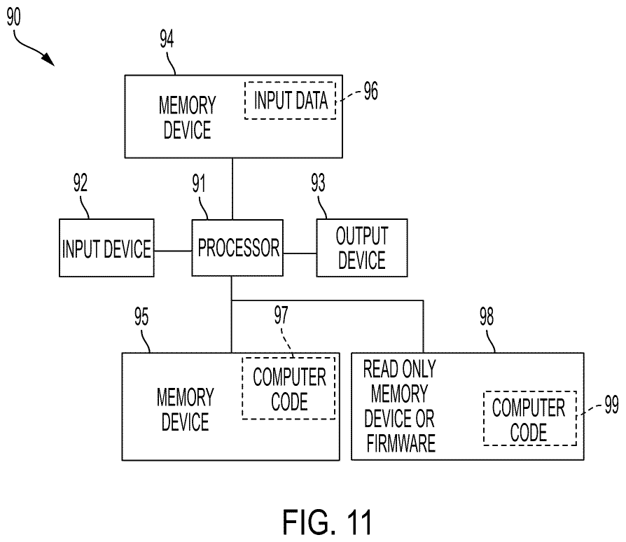

FIG. 11 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 11 shows the computer system 90 as a particular configuration of hardware and software, any configuration of hardware and software, as would be known to a person of ordinary skill in the art, may be utilized for the purposes stated supra in conjunction with the particular computer system 90 of FIG. 11. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

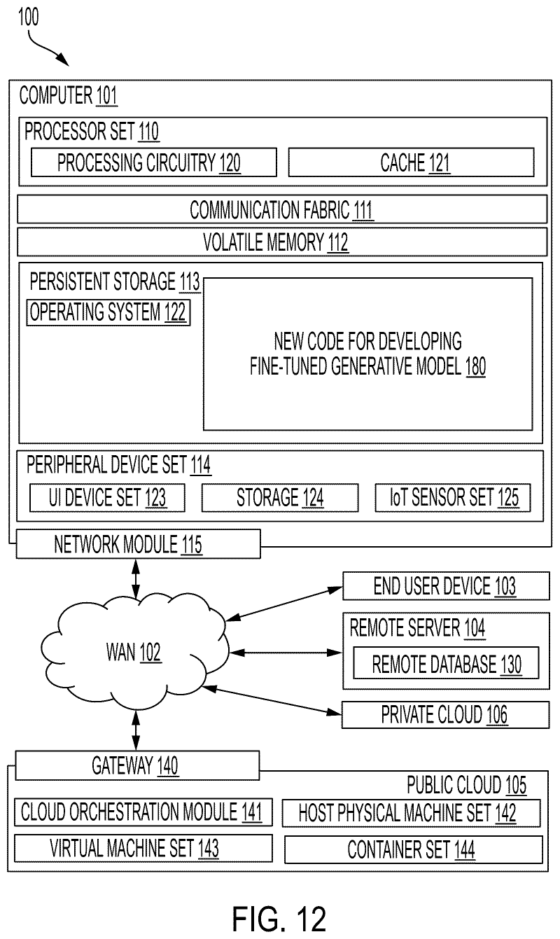

FIG. 12 depicts a computing environment 100 which contains an example of an environment for the execution of at least some of the computer code involved in performing the inventive methods, in accordance with embodiments of the present invention. Such computer code includes new code for developing a fine-tuned generative model 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for developing a fine-tuned generative model (GM) that receives metadata and multiple choices as input and is configured to select a best choice, from the multiple choices, for describing the metadata, said method comprising:
generating, by one or more processors of a computer system, training data as input for training a pre-trained GM to become the fine-tuned GM, said training data comprising P input prompts, wherein P is at least 4, wherein each input prompt of the P input prompts comprises a metadata, multiple choices comprising positive choices and a negative choice, and a best choice of the multiple choices for describing the metadata, and wherein the GM is a neural network of interconnected nodes with each node having an associated weight; and
training, by the one or more processors, the pre-trained GM to become the fine-tuned GM, using reinforcement learning and using the training data as input to the training, wherein the training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then looping back to said performing the nested iterative process in which N new input prompts are sampled randomly from the P input prompts, wherein K is at least 2.

2. The method of claim 1, wherein each iteration k (k=1, . . . , K) of the iterative process comprises:
randomly sampling I input prompts from the N input prompts, wherein I<N;
for each input prompt i of the I input prompts: tokenizing input prompt i into p input tokens resulting in generation of T+1 output tokens; and for each output token t (t=0, . . . , T) of input prompt i, computing a reward (R_{i,t}) that combines a Kullback-Leibler (KL) reward with a similarity-based reward that depends on a similarity score between the GM's output and the multiple choices of input prompt i;
computing a policy optimization loss (L) based on the rewards R_{i,t} for all of the T+1 output tokens for each of the I input prompts; and
updating each node based by an additive amount Δ∇L, wherein α is an inputted constant learning rate and ∇L is a gradient of L that is specific to each node.

3. The method of claim 2, wherein if t<T then the reward R_{i,t} is the KL reward, and wherein if t=T then the reward R_{i,t} is a sum of the KL reward and the similarity-based reward.

4. The method of claim 2, wherein the similarity-based reward is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

5. The method of claim 2, wherein said determining whether the iterative process has converged comprises determining whether ∥∇L∥²≤ε at each node for a specified tolerance ε, and if so or if not then determining that the iterative process has converged or has not converged, respectively.

6. The method of claim 2, wherein said generating the training data comprises:
providing a list of metadata, a list of glossary items, and a ground truth for one or more metadata, wherein for each metadata having a ground truth, the ground truth points to one or more glossary items, and wherein each glossary item comprises a label and a description, and for each metadata:
computing a similarity metric in an embedding space between the metadata and each glossary item in the list of glossary items;
selecting H glossary items in the list of glossary having H highest similarity metrics;
randomly selecting H sub-chunks, each sub-chunk of size G being a subset of the H glossary items, wherein G<H;
for each sub-chunk s (s=1, . . . , S): (i) generating a multiple choice input prompt comprising the metadata, G+1 choices consisting of the G glossary items as positive choices and a none-of-the-above (NOTA) choice as a negative choice; and (ii) selecting a best choice of the G+1 choices, wherein the multiple choice input prompt further comprises the best choice.

7. The method of claim 6, wherein said selecting the best choice comprises:
ascertaining whether a ground truth pointing to at least one choice of the G positive choices for the metadata exists, and if so then selecting the best choice as being one choice of the at least one choice, and if not selecting the best choice as being the NOTA choice.

8. The method of claim 2, said method further comprising:
verifying, by the one or more processors, the fine-tuned GM; and
executing, by the one or more processors, the verified fine-tuned GM to determine descriptions of given metadata.

9. A computer program product, comprising one or more computer readable hardware storage devices having computer readable program code stored therein, said program code containing instructions executable by one or more processors of a computer system to implement a method for developing a fine-tuned generative model (GM) that receives metadata and multiple choices as input and is configured to select a best choice, from the multiple choices, for describing the metadata, said method comprising:
generating, by the one or more processors, training data as input for training a pre-trained GM to become the fine-tuned GM, said training data comprising P input prompts, wherein P is at least 4, wherein each input prompt of the P input prompts comprises a metadata, multiple choices comprising positive choices and a negative choice, and a best choice of the multiple choices for describing the metadata, and wherein the GM is a neural network of interconnected nodes with each node having an associated weight; and
training, by the one or more processors, the pre-trained GM to become the fine-tuned GM, using reinforcement learning and using the training data as input to the training, wherein the training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then looping back to said performing the nested iterative process in which N new input prompts are sampled randomly from the P input prompts, wherein K is at least 2.

10. The computer program product of claim 9, wherein each iteration k (k=1, . . . , K) of the iterative process comprises:
randomly sampling I input prompts from the N input prompts, wherein I<N;
for each input prompt i of the I input prompts: tokenizing input prompt i into p input tokens resulting in generation of T+1 output tokens; and for each output token t (t=0, . . . , T) of input prompt i, computing a reward (R_{i,t}) that combines a Kullback-Leibler (KL) reward with a similarity-based reward that depends on a similarity score between the GM's output and the multiple choices of input prompt i;
computing a policy optimization loss (L) based on the rewards R_{i,t} for all of the T+1 output tokens for each of the I input prompts; and
updating each node based by an additive amount Δ∇L, wherein α is an inputted constant learning rate and ∇L is a gradient of L that is specific to each node.

11. The computer program product of claim 10, wherein if t<T then the reward R_{i,t} is the KL reward, and wherein if t=T then the reward R_{i,t} is a sum of the KL reward and the similarity-based reward.

12. The computer program product of claim 10, wherein the similarity-based reward is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

13. The computer program product of claim 10, wherein said determining whether the iterative process has converged comprises determining whether ∥∇L∥²ε at each node for a specified tolerance ε, and if so or if not then determining that the iterative process has converged or has not converged, respectively.

14. The computer program product of claim 10, wherein said generating the training data comprises:
providing a list of metadata, a list of glossary items, and a ground truth for one or more metadata, wherein for each metadata having a ground truth, the ground truth points to one or more glossary items, and wherein each glossary item comprises a label and a description, and for each metadata:
computing a similarity metric in an embedding space between the metadata and each glossary item in the list of glossary items;
selecting H glossary items in the list of glossary having H highest similarity metrics;
randomly selecting H sub-chunks, each sub-chunk of size G being a subset of the H glossary items, wherein G<H;
for each sub-chunk s (s=1, . . . , S): (i) generating a multiple choice input prompt comprising the metadata, G+1 choices consisting of the G glossary items as positive choices and a none-of-the-above (NOTA) choice as a negative choice; and (ii) selecting a best choice of the G+1 choices, wherein the multiple choice input prompt further comprises the best choice.

15. A computer system, comprising one or more processors, one or more memories, and one or more computer readable hardware storage devices, said one or more hardware storage devices containing program code executable by the one or more processors via the one or more memories to implement a method for developing a fine-tuned generative model (GM) that receives a metadata and multiple choices as input and is configured to select a best choice, from the multiple choices, for describing the metadata, said method comprising:
generating, by the one or more processors, training data as input for training a pre-trained GM to become the fine-tuned GM, said training data comprising P input prompts, wherein P is at least 4, wherein each input prompt of the P input prompts comprises a metadata, multiple choices comprising positive choices and a negative choice, and a best choice of the multiple choices for describing the metadata, and wherein the GM is a neural network of interconnected nodes with each node having an associated weight; and
training, by the one or more processors, the pre-trained GM to become the fine-tuned GM, using reinforcement learning and using the training data as input to the training, wherein the training comprises: performing a nested iterative process in which N input prompts are sampled randomly from the P input prompts subject to N<P, followed by iteratively using the N input prompts to dynamically update the weights for a maximum of K iterations, wherein if the weights have not converged after K iterations have been performed, then looping back to said performing the nested iterative process in which N new input prompts are sampled randomly from the P input prompts, wherein K is at least 2.

16. The computer system of claim 15, wherein each iteration k (k=1, . . . , K) of the iterative process comprises:
randomly sampling I input prompts from the N input prompts, wherein I<N;
for each input prompt i of the I input prompts: tokenizing input prompt i into p input tokens resulting in generation of T+1 output tokens; and for each output token t (t=0, . . . , T) of input prompt i, computing a reward (R_{i,t}) that combines a Kullback-Leibler (KL) reward with a similarity-based reward that depends on a similarity score between the GM's output and the multiple choices of input prompt i;
computing a policy optimization loss (L) based on the rewards R_{i,t} for all of the T+1 output tokens for each of the I input prompts; and
updating each node based by an additive amount Δ∇L, wherein α is an inputted constant learning rate and ∇L is a gradient of L that is specific to each node.

17. The computer system of claim 16, wherein if t<T then the reward R_{i,t} is the KL reward, and wherein if t=T then the reward R_{i,t} is a sum of the KL reward and the similarity-based reward.

18. The computer system of claim 16, wherein the similarity-based reward is a linear combination of R_{gt} and a summation over Rₒₜₕₑᵣ, wherein R_{gt} is a similarity score between the GM's output and the best choice for input prompt i, and wherein Rₒₜₕₑᵣ is a similarity score between the GM's output and each remaining choice of the multiple choices for input prompt i.

19. The computer system of claim 16, wherein said determining whether the iterative process has converged comprises determining whether ∥∇L∥²≤ε at each node for a specified tolerance ε, and if so or if not then determining that the iterative process has converged or has not converged, respectively.

20. The computer system of claim 16, wherein said generating the training data comprises:
providing a list of metadata, a list of glossary items, and a ground truth for one or more metadata, wherein for each metadata having a ground truth, the ground truth points to one or more glossary items, and wherein each glossary item comprises a label and a description, and for each metadata:
computing a similarity metric in an embedding space between the metadata and each glossary item in the list of glossary items;
selecting H glossary items in the list of glossary having H highest similarity metrics;
randomly selecting H sub-chunks, each sub-chunk of size G being a subset of the H glossary items, wherein G<H;
for each sub-chunk s (s=1, . . . , S): (i) generating a multiple choice input prompt comprising the metadata, G+1 choices consisting of the G glossary items as positive choices and a none-of-the-above (NOTA) choice as a negative choice; and (ii) selecting a best choice of the G+1 choices, wherein the multiple choice input prompt further comprises the best choice.
